(19) United States
(12) Patent Application Publication
(10) Pub. No.: US 2022/0235842 A1
(43) Pub. Date: Jul. 28, 2022

(54) VIBRATION DAMPING BAND AND MUFFLER

(71) Applicant: FUTABA INDUSTRIAL CO., LTD., Okazaki-shi (JP)

(72) Inventors: Shunsuke Matsui, Okazaki-shi (JP); Tsuneyuki Higashino, Okazaki-shi (JP)

(21) Appl. No.: 17/569,935

(22) Filed: Jan. 6, 2022

(30) Foreign Application Priority Data
Jan. 27, 2021 (JP) 2021-011256

(51) Int. Cl. F16F 7/104; F16L 55/033

(52) U.S. Cl. CPC F16F 7/104; F16L 55/0335

(57) ABSTRACT

A vibration damping band to be mounted on an outer circumferential surface of a muffler main body includes a vibration damping material and an outer panel. The vibration damping material having elasticity is configured to be arranged on the outer circumferential surface of the muffler main body. The outer panel is arranged outside an outer lateral surface of the vibration damping material.

### CROSS-REFERENCE TO RELATED APPLICATIONS

This application claims the benefit of Japanese Patent Application No. 2021-011256 filed on Jan. 27, 2021 with the Japan Patent Office, the entire disclosure of which is incorporated herein by reference.

### BACKGROUND

The present disclosure relates to a vibration damping band and a muffler.

Japanese Unexamined Patent Application Publication No. 2018-53794 discloses a muffler covered with a fibrous thermal insulation material. In the muffler, a thermal insulation material is arranged to have a larger density in areas of an inner tube and an outer tube that are prone to vibration than in other areas. This causes the areas having a larger density to have a relatively high stiffness, and to thereby function as a vibration damper that reduces vibration.

### SUMMARY

However, the muffler disclosed in Japanese Unexamined Patent Application Publication No. 2018-53794 has a problem that vibration is not damped sufficiently and reduction in radiated noise is insufficient.

One aspect of the present disclosure preferably provides a vibration damping band and a muffler that reduce radiated noise appropriately.

An embodiment of the present disclosure is a vibration damping band to be mounted on an outer circumferential surface of a muffler main body. The vibration damping band comprises a vibration damping material and an outer panel. The vibration damping material has elasticity and is configured to be arranged on the outer circumferential surface of the muffler main body. The outer panel is arranged outside an outer lateral surface of the vibration damping material.

With this configuration, radiated noise generated due to vibration of the muffler main body can be suitably reduced. The reason is considered as follows. Since the vibration damping material has elasticity, a force of pulling the vibration damping material in a shearing direction by a surface of the muffler main body is generated when the muffler main body vibrates while the vibration damping band is mounted on the muffler main body. When the vibration damping material is pulled and extended, vibration energy is converted into thermal energy by internal friction of the vibration damping material. Thus, vibration is damped, and radiated noise from the muffler main body can be reduced.

In the vibration damping band described above, the vibration damping material may be fixed to the outer panel at least in a first fixing position and a second fixing position of the outer panel, and the vibration damping material may comprise at least a first portion fixed in the first fixing position and a second portion fixed in the second fixing position and may be extendable between the first portion and the second portion

With this configuration, since the vibration damping material is fixed in two positions of the outer panel spaced from each other, it is easy to form a state where the vibration damping material is extended between the two portions, that is, a state where a tension is applied to the vibration damping material. Thus, when the vibration damping band is mounted on the muffler main body, the muffler main body and the vibration damping material are easily brought into close contact with each other. This facilitates generation of a shearing stress between the muffler main body and the vibration damping material when the muffler main body vibrates. Accordingly, radiated noise can be reduced suitably.

In the above-described vibration damping band, a length of the vibration damping material from the first portion to the second portion may be shorter than a length from the first fixing position to the second fixing position of the outer panel.

With this configuration, when the outer panel is fixed along the outer circumferential surface of the muffler main body, the vibration damping material abuts the outer circumferential surface of the muffler main body. Also, a part of the vibration damping material from the first portion to the second portion is extended so as to approach a length from the first fixing position to the second fixing position of the outer panel. The vibration damping material contacts the muffler main body in a state where the vibration damping material is applied with a tension and provides a high vibration damping effect. Accordingly, radiated noise can be reduced suitably.

In the above-described vibration damping band, the vibration damping material may be fixed to the outer panel at least in two positions of the outer panel. With this configuration, when the muffler main body is inserted inside the vibration damping material, and thereby the vibration damping band is mounted on the muffler main body, the vibration damping material is applied with a tension. Accordingly, radiated noise can be reduced suitably.

The above-described vibration damping band may further comprise a swaging component. Also, the outer panel and the vibration damping material may be folded and swaged by the swaging component, and thereby the outer panel and the vibration damping material may be fixed together. This configuration allows firm fixation of the outer panel and the vibration damping material.

In the above-described vibration damping band, the outer panel may comprise two or more members configured to be arranged along an outer circumferential direction of the muffler main body, and the two or more members may surround the outer circumferential surface of the muffler main body. With this configuration, when the two or more members are mounted on the muffler main body, the vibration damping material is applied with a tension. Accordingly, radiated noise can be reduced suitably.

An embodiment of the present disclosure is a muffler that comprises a muffler main body and a vibration damping band. The vibration damping band is mounted on an outer circumferential surface of the muffler main body. Also, the vibration damping band comprises a vibration damping material and an outer panel. The vibration damping material has elasticity and is arranged on the outer circumferential surface of the muffler main body. The outer panel is arranged on an outer lateral surface of the vibration damping material.

With this configuration, when the vibration damping material is mounted so as to be held between the outer circumferential surface of the muffler main body and the outer panel, a tension is applied to the vibration damping material having elasticity. Accordingly, radiated noise can be reduced suitably.

In the above-described muffler, the muffler main body may comprise at least one separator. The vibration damping band may be provided in a position of the outer circumferential surface of the muffler main body, the position being spaced from a region in which an outer periphery of the at least one separator abuts an inner circumferential surface of the muffler main body.

With this configuration, the vibration damping band is arranged on a part of the muffler main body which easily vibrates. Accordingly, radiated noise can be reduced more suitably.

### BRIEF DESCRIPTION OF THE DRAWINGS

Some embodiments of the present disclosure will be described hereinafter by way of example with reference to the accompanying drawings, in which:

FIG. 1 is a schematic view of a muffler;

FIG. 2 is a schematic side view of a vibration damping band;

FIG. 3 is a schematic perspective view showing a state in which the vibration damping band is mounted on a muffler main body;

FIG. 4A is a schematic sectional view showing the state in which the vibration damping band is mounted on the muffler main body;

FIG. 4B is a schematic top view showing the state in which the vibration damping band is mounted on the muffler main body;

FIG. 5A is a view of illustrating swaging between an outer panel and a vibration damping material using a swaging component;

FIG. 5B is a schematic top view of the vibration damping band in a state in which the vibration damping band is swaged using the swaging component;

FIG. 5C is a sectional view along a VC-VC line in FIG. 5A;

FIG. 6A is a view illustrating fastening of the outer panel and the vibration damping material using a bolt and a nut;

FIG. 6B is a schematic top view of the vibration damping band in a state in which the outer panel and the vibration damping material are fastened together using the bolt and the nut;

FIG. 7 is a schematic side view of a vibration damping band having an upper side portion and a lower side portion;

FIG. 8 is a schematic side view of a vibration damping band having only an upper side portion;

FIG. 9 is a schematic side view of a vibration damping band configured to be not fixed in a second fixing position; and

FIG. 10 is a schematic view showing a state in which two vibration damping bands are mounted on the muffler main body so as to intersect each other.

### DETAILED DESCRIPTION OF EXEMPLARY EMBODIMENTS

### 1. Embodiment

### 1-1. Configuration

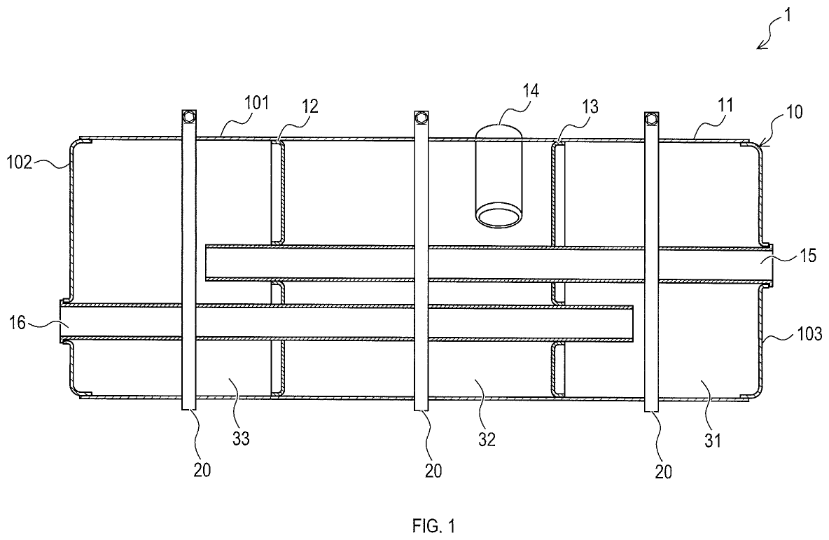

A muffler 1 shown in FIG. 1 is installed in a vehicle. The muffler 1 forms a part of an exhaust flow path of exhaust gas discharged from an internal combustion engine of the vehicle. The muffler 1 comprises a muffler main body 10 and three vibration damping bands 20. FIG. 1 is a view prepared by superimposing a side view of the vibration damping bands 20 on a sectional view of the muffler main body 10.

The muffler main body 10 comprises a casing 11, a first separator 12, a second separator 13, an inlet pipe 14, a first outlet pipe 15, and a second outlet pipe 16.

<Casing>

The casing 11 comprises therein an exhaust flow path to reduce exhaust noise. The casing 11 comprises a shell member 101, a front lid member 102, and a rear lid member 103. The shell member 101 is a cylindrical member extending in a specified extending direction. The front lid member 102 and the rear lid member 103 close both end openings of the shell member 101 along the extending direction. The extending direction of the shell member 101 is an extending direction of the casing 11. However, the extending direction is used for convenience in indicating a direction, and thus a length of the casing 11 in the extending direction may be smaller than a length between wall surfaces passing along a central axis in a cross-section orthogonal to the extending direction.

<Separator>

The first separator 12 and the second separator 13 are partition members to partition an internal space surrounded by an inner wall surface of the casing 11 into two or more spaces. The internal space is sectioned into two or more chambers by the first separator 12 and the second separator 13. In the present embodiment, the internal space is sectioned into three chambers, i.e., a first chamber 31, a second chamber 32, and a third chamber 33 starting from a side of the rear lid member 103. The first separator 12 and the second separator 13 each have two or more holes communicating with these chambers, and the exhaust gas is allowed to flow into other chambers through these holes.

<Inlet Pipe>

The inlet pipe 14 is a pipe to introduce the exhaust gas from the internal combustion engine into the casing 11. The inlet pipe 14 is provided so as to penetrate a portion of the shell member 101 that forms the second chamber 32. The inlet pipe 14 comprises a downstream end opened in the second chamber 32.

<Outlet Pipe>

The first outlet pipe 15 and the second outlet pipe 16 are pipes to discharge the exhaust gas from the casing 11. The exhaust gas that flows in from the inlet pipe 14 is discharged through the first outlet pipe 15 and the second outlet pipe 16. The first outlet pipe 15 and the second outlet pipe 16 are each coupled to a not shown pipe located downstream of the muffler main body 10. The first outlet pipe 15 is provided so as to penetrate the rear lid member 103, the second separator 13, and the first separator 12. The first outlet pipe 15 comprises an upstream end opened to the third chamber 33. The second outlet pipe 16 is provided so as to penetrate the front lid member 102, the first separator 12, and the second separator 13. The second outlet pipe 16 comprises an upstream end opened to the first chamber 31.

<Vibration Damping Band>

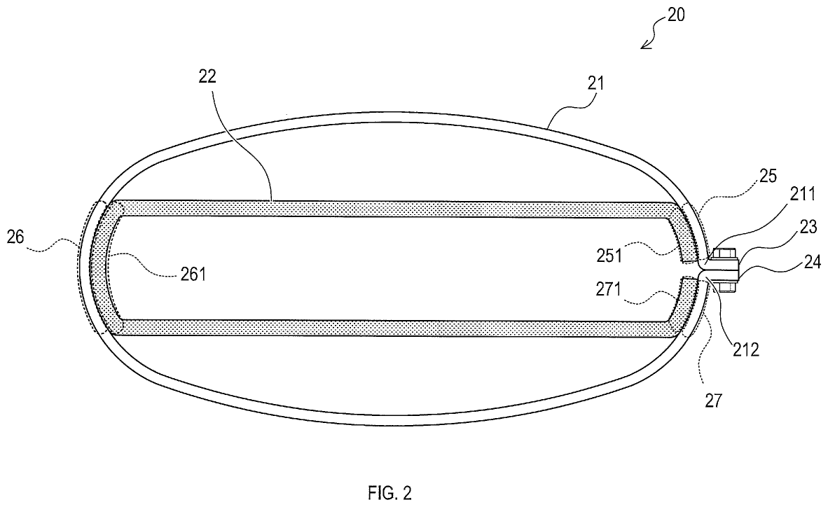

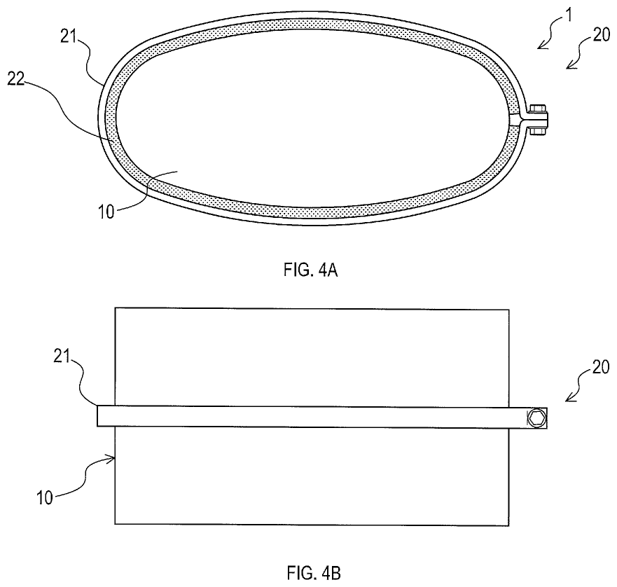

As shown in FIGS. 2 to 4, the vibration damping band 20 comprises an outer panel 21 and a vibration damping material 22.

The outer panel 21 is a member formed of metal and having a band shape. The outer panel 21 is formed in a shape along a curved outer circumferential surface of the muffler main body 10 so as to surround the outer circumferential surface of the muffler main body 10. The outer panel 21 is arranged outside of the vibration damping material 22. The outer panel 21 has a generally C-shaped cross-section along a direction orthogonal to a width direction of the outer panel 21. The width direction of the outer panel 21 here means a width direction of the aforementioned band shape.

The outer panel 21 comprises plate-shaped coupling pieces 23 and 24 extending outward from the first end 211 and the second end 212, respectively, of the outer panel 21. The coupling pieces 23 and 24 are configured to be fastened together facing each other by a bolt and a nut.

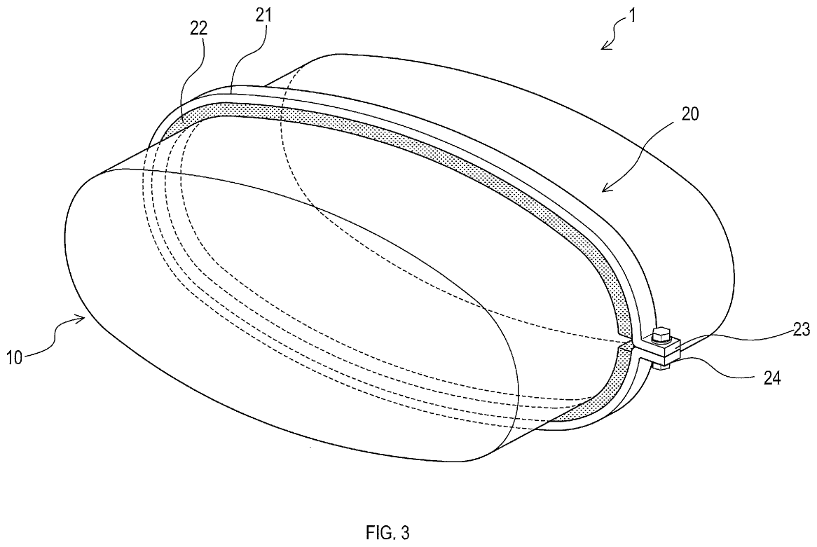

The vibration damping material 22 is configured to be arranged on an outer circumferential surface of the muffler main body 10. The vibration damping material 22 is formed of an elastic member. Specifically, the vibration damping material 22 is a member extendable in response to a load applied in a pulling direction, and is elastically deformed in an extension and contraction direction. The extension and contraction direction is a longitudinal direction of the vibration damping material 22. The vibration damping material 22 is configured not to reach an elastic limit at least in a state shown in FIG. 3 where the vibration damping material 22 is mounted on the muffler main body 10 and extended. The vibration damping material 22 may be formed, for example, by knitting long fibers. Examples of the long fiber may include glass fiber, ceramic fiber, silica fiber, and stainless steel material.

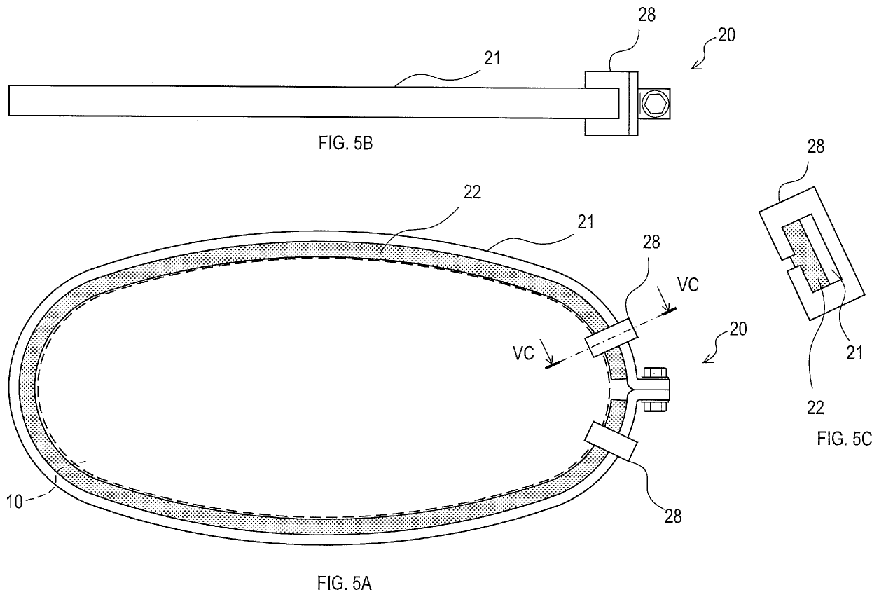

The vibration damping material 22 is fixed to an inner circumferential surface of the outer panel 21 in a fixing position 25, a second fixing position 26, and a third fixing position 27 of the outer panel 21. The first fixing position 25 and the third fixing position 27 are provided in vicinities of the coupling pieces 23 and 24. The second fixing position 26 is provided opposed to the first fixing position 25 and the third fixing position 27. Portions of the vibration damping material 22 fixed to the inner circumferential surface of the outer panel 21 in the first fixing position 25, the second fixing position 26, and the third fixing position 27 are referred to as “a first portion 251”, “a second portion 261”, and “a third portion 271”, respectively. Specifically, the vibration damping material 22 is swaged, for example, by crimping and fixed to the inner circumferential surface of the outer panel 21. As shown in FIG. 5, for example, the outer panel 21 and the vibration damping material 22 are folded and swaged by a swaging component 28, and thereby the vibration damping material 22 is fixed to the inner circumferential surface of the outer panel 21. Note that any configuration for fixation, such as the swaging component 28, is not shown in figures other than FIG. 5.

Returning to FIG. 2, the vibration damping material 22 is fixed to the outer panel 21 in a position of a chord of the outer panel 21 with a tension applied in the extension and contraction direction. The vibration damping material 22 with a tension applied in the extension and contraction direction is longer than a natural length. In this case, a length of the vibration damping material 22 from the first portion 251 to the second portion 261 is shorter than a length of the outer panel 21 from the first fixing position 25 to the second fixing position 26. Also, a length of the vibration damping material 22 from the second portion 261 to the third portion 271 is shorter than a length of the outer panel 21 from the second fixing position 26 to the third fixing position 27. In positions other than the first fixing position 25, the second fixing position 26, and the third fixing position 27, an interspace is formed between the vibration damping material 22 and the outer panel 21.

### 1-2. Mounting of Vibration Damping Band on Muffler Main Body

Here, a description will be given of one of the three vibration damping bands 20 to be mounted on the muffler main body 10. The vibration damping band 20 is mounted on the muffler main body 10 so as to be arranged along the outer circumferential surface of the muffler main body 10. In other words, the vibration damping band 20 is adjacent to the outer circumferential surface of the muffler main body 10 through the vibration damping material 22.

First, the outer panel 21 is opened in a direction of separating the coupling pieces 23 and 24 of the outer panel 21 from each other.

Then, the vibration damping band 20 is put around the muffler main body 10 such that the vibration damping material 22 is brought into close contact with the muffler main body 10. Specifically, as shown in FIG. 1, the vibration damping band 20 is mounted in a position on the outer circumferential surface of the muffler main body 10, the position being spaced from regions in which outer peripheries of the first separator 12 and the second separator 13 abut an inner circumferential surface of the muffler main body 10. More specifically, the vibration damping band 20 is mounted in a position on the outer circumferential surface of the muffler main body 10, the position being different from regions in which outer peripheries of the first separator 12 and the second separator 13 are connected to the muffler main body 10.

Subsequently, the vibration damping band 20 with the coupling pieces 23 and 24 facing each other is fixed to the muffler main body 10 using a bolt. In the present embodiment, the vibration damping material 22 is already applied with a tension before the mounting of the vibration damping band 20. When the vibration damping band 20 is mounted on the muffler main body 10, the vibration damping material 22 is further extended and thus is applied with a tension greater than the tension before the mounting. In this state, the vibration damping material 22 is arranged so as to abut the outer circumferential surface of the muffler main body 10, and is held between the muffler main body 10 and the outer panel 21. That is, the vibration damping material 22 is easily brought into close contact with the muffler main body 10.

In the present embodiment, as shown in FIG. 1, the three vibration damping bands 20 are mounted. One of the vibration damping bands 20 is mounted between the front lid member 102 and the first separator 12. Another one of the vibration damping bands 20 is mounted between the first separator 12 and the second separator 13. The remaining one of the vibration damping bands 20 is mounted between the second separator 13 and the rear lid member 103. In other words, one vibration damping band 20 is mounted for each of the chambers 31 to 33. Each position in which the vibration damping band 20 is mounted corresponds to an amplitude antinode, at which an amplitude of the muffler main body 10 by vibration is maximum while the muffler main body 10 is vibrating.

### 1-3. Effects

According to the embodiment described above, the following effects are obtained:

(1a) In the muffler 1 of the present embodiment, the vibration damping material 22, which is tensioned between the first portion 251 and the second portion 261 as well as between the second portion 261 and the third portion 271, is arranged so as to be held between the outer circumferential surface of the muffler main body 10 and the outer panel 21. With this configuration, radiated noise generated due to vibration of the muffler main body 10 can be reduced appropriately. The reason will be described below. Since the vibration damping material 22 is tensioned, when the muffler main body 10 vibrates, a force of pulling the vibration damping material 22 in a shearing direction by a surface of the muffler main body 10 is generated on the vibration damping material 22. When the vibration damping material 22 is pulled and extended, vibration energy is converted into thermal energy by internal friction of the vibration damping material 22. Specifically, vibration energy is converted into thermal energy by friction caused by rubbing of long fibers forming the vibration damping material 22. Thus, vibration is damped, and radiated noise from the muffler main body 10 can be reduced.

The extension and contraction direction of the vibration damping material 22 coincides with the circumferential direction of the muffler main body 10. Accordingly, in the present embodiment, the vibration damping material 22 facilitates damping of the vibration in the circumferential direction of the muffler main body 10.

(1b) The length of the vibration damping material 22 from the first portion 251 to the second portion 261 extended with a specified extension force is shorter than the length of the outer panel 21 from the first fixing position 25 to the second fixing position 26. With this configuration, when the outer panel 21 is fixed along the outer circumferential surface of the muffler main body 10, the vibration damping material 22 abuts the outer circumferential surface of the muffler main body 10. Also, a part of the vibration damping material 22 between the first portion 251 and the second portion 261 is extended to approach the length of the outer panel 21 from the first fixing position 25 to the second fixing position 26. Thus, the vibration damping material 22 contacts the muffler main body 10 in a tensioned state providing a high vibration damping effect. Accordingly, radiated noise can be reduced appropriately. Also, a part of the vibration damping material 22 between the second portion 261 and the third portion 271 also achieves similar effects to those of the part between the first portion 251 and the second portion 261 as described above.

(1c) The vibration damping material 22 is fixed to the outer panel 21 with a tension applied between the first portion 251 and the second portion 261. Also, the vibration damping material 22 is fixed to the outer panel 21 with a tension applied between the second portion 261 and the third portion 271. With this configuration, the vibration damping material 22 is already tensioned before the mounting of the vibration damping band 20 on the muffler main body 10. In other words, when the vibration damping band 20 is mounted on the muffler main body 10, a greater tension is applied to the vibration damping material 22. Accordingly, radiated noise can be reduced appropriately.

(1d) The outer panel 21 has a shape along the curved outer circumferential surface of the muffler main body 10, and the vibration damping material 22 is fixed to the outer panel 21 in the position of a chord of the outer panel 21. With this configuration, the outer panel 21 can hold the vibration damping material 22 with a suitable force over a wide area. Also, the vibration damping material 22 is easily tensioned, and thus can reduce radiated noise appropriately. Here, “the position of a chord of the outer panel 21” means the position of a chord in case of assuming the outer panel 21 to be a circular arc.

(1e) The vibration damping band 20 is provided in the position of the outer circumferential surface of the muffler main body 10, the position being spaced from regions in which outer peripheries of the first separator 12 and the second separator 13 abut the inner circumferential surface of the muffler main body 10. With this configuration, the vibration damping band 20 is arranged on a part, which easily vibrates, of the muffler main body 10. Accordingly, radiated noise can be reduced more appropriately.

(1f) The vibration damping band 20 is mounted for each of the chambers 31 to 33. With this configuration, the vibration damping band 20 can be arranged on a part, which easily vibrates, of the muffler main body 10 for each of the chambers 31 to 33. Accordingly, radiated noise can be reduced more appropriately.

### 2. Other Embodiments

Although one embodiment of the present disclosure has been described above, it is to be understood that the present disclosure is not limited to the above-described embodiment but may be in various forms within the technical scope of the present disclosure.

(2a) In the above-described embodiment, the vibration damping material 22 is arranged on the outer panel 21 with a tension applied before the vibration damping band 20 is mounted on the muffler main body 10. However, for example, the vibration damping material 22 may be arranged on the outer panel 21 with no tension applied. Even in this case, for example, if the length of the vibration damping material 22 from the first portion 251 to the second portion 261 when extended with a specified extension force is shorter than the length of the outer panel 21 from the first fixing position 25 to the second fixing position 26, then the vibration damping material 22 is extended and is applied with a tension once the vibration damping band 20 is mounted on the muffler main body 10, and a high vibration damping effect can be obtained. That is, in a state where the outer panel 21 is arranged on the muffler main body 10 through the vibration damping material 22, the vibration damping material 22 is tensioned between the first portion 251 and the second portion 261, and provides a high vibration damping effect.

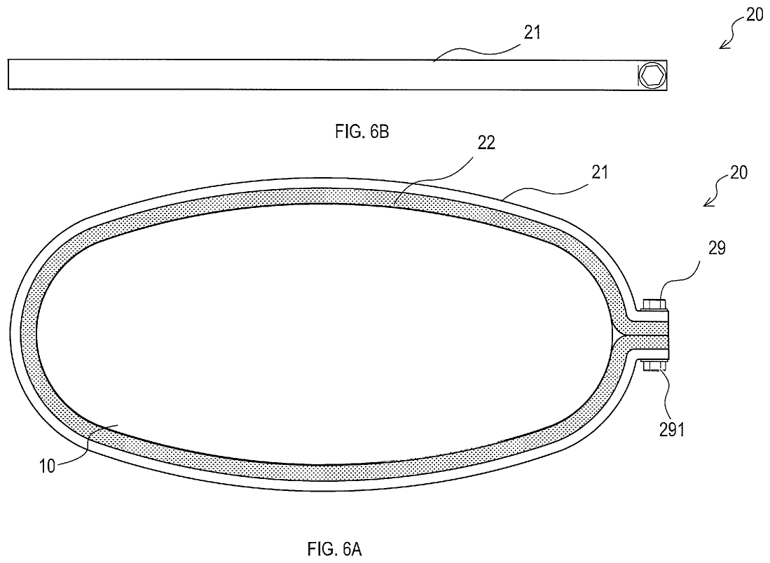

(2b) Although the vibration damping material 22 is fixed to the outer panel 21 by being swaged by the swaging component 28 in the above-described embodiment, a method of fixing the vibration damping material 22 to the outer panel 21 is not limited to that. For example, as shown in FIGS. 6A and 6B, the outer panel 21, the vibration damping material 22, and the muffler main body 10 may be fastened and fixed together with a bolt 29 and a nut 291.

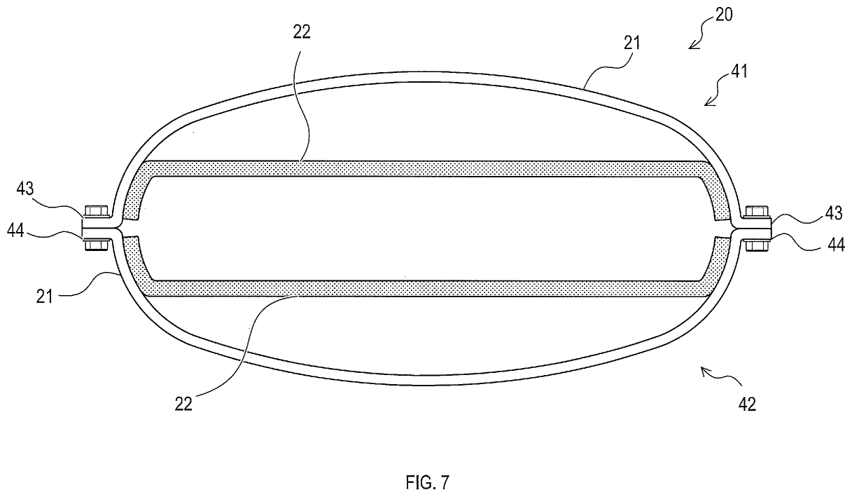

(2c) Although the vibration damping band 20 has a shape surrounding an entirety of the outer circumferential surface of the muffler main body 10 in the above-described embodiment, the shape of the vibration damping band 20 is not limited to that. For example, as shown in FIG. 7, the vibration damping band 20 may comprise an upper side portion 41 and a lower side portion 42. The upper side portion 41 and the lower side portion 42 each have a sectional shape obtained by dividing a circumference of an ellipse by its long axis. The upper side portion 41 comprises plate-shaped coupling pieces 43 extending outward from respective ends of the upper side portion 41, and the lower side portion 42 comprises plate-shaped coupling pieces 44 extending outward from respective ends of the lower side portion 42. In this case, the coupling pieces 43 of the upper side portion 41 and the corresponding coupling pieces 44 of the lower side portion 42 are each fastened together by a bolt and a nut, and thereby the vibration damping band 20 is mounted on the muffler main body 10.

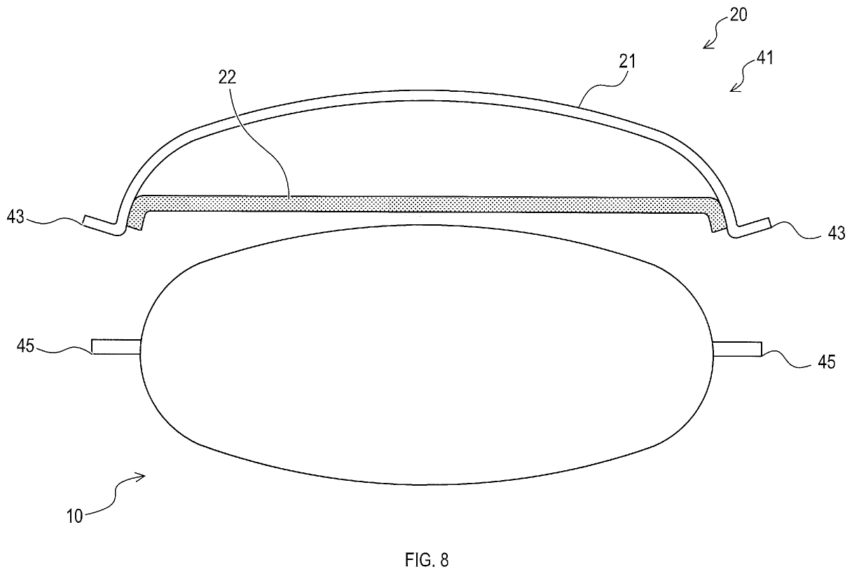

Also, as shown in FIG. 8, the vibration damping band 20 may comprise only the upper side portion 41 without the lower side portion 42. In this case, the muffler main body 10 comprises plate-shaped coupling pieces 45 extending outward from the muffler main body 10. The coupling pieces 43 of the upper side portion 41 and the corresponding coupling pieces 45 of the muffler main body 10 are each fastened together by a bolt and a nut, and thereby the vibration damping band 20 is mounted on the muffler main body 10.

Further, the vibration damping band 20 may be mounted along the extending direction of the muffler main body 10, although which is not shown.

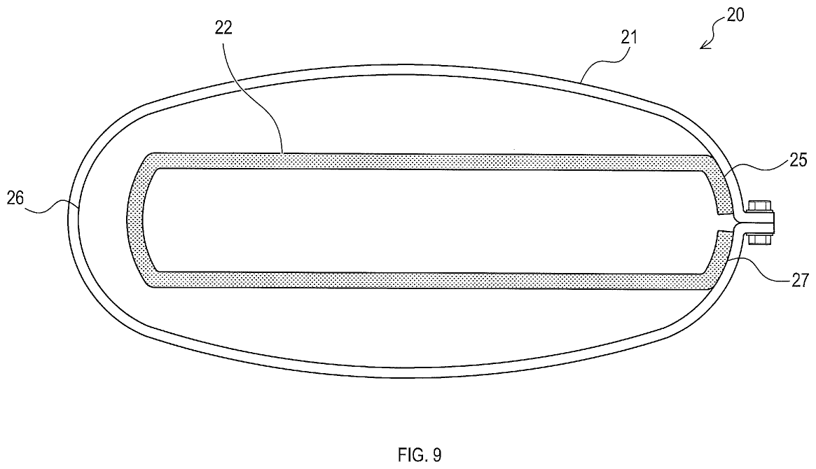

(2d) Although the vibration damping material 22 is fixed to the outer panel 21 in the position of the chord of the outer panel 21 in the above-described embodiment, the position of fixing the vibration damping material 22 to the outer panel 21 is not limited to that. For example, as shown in FIG. 9, the vibration damping material 22 may be fixed in the first fixing position 25 and the third fixing position 27, while not being fixed in the second fixing position 26. In this case, when the muffler main body 10 is inserted inside the vibration damping material 22 having a band shape and thereby the vibration damping band 20 is mounted on the muffler main body 10, the vibration damping material 22 is applied with a tension.

(2e) Although three vibration damping bands 20 are mounted on the muffler main body 10 in the above-described embodiment, the number of the vibration damping bands 20 to be mounted is not limited to three. For example, the number of the vibration damping bands 20 may be two or less, or four or more.

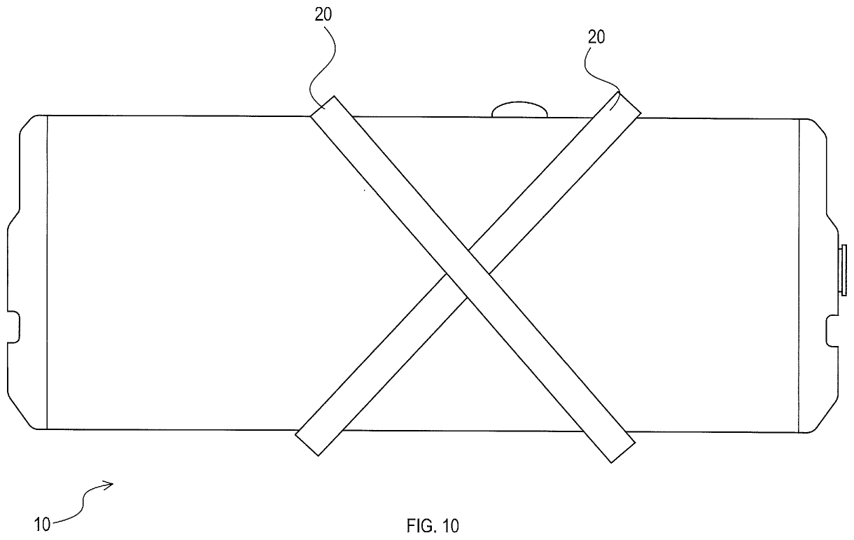

(2f) Although one vibration damping band 20 is mounted for each of the chambers 31 to 33 in the above-described embodiment, a configuration of mounting the vibration damping bands 20 on the muffler main body 10 is not limited to that. For example, two or more vibration damping bands 20 may be mounted on the muffler main body 10 such that the two or more vibration damping bands 20 are intersecting one another. For example, as shown in FIG. 10, two vibration damping bands 20 may be mounted on the muffler main body 10 such that the two vibration damping bands 20 are intersecting each other. Specifically, one of the vibration damping bands 20 is mounted to pass an upper end of the first chamber 31, a middle part of the second chamber 32, and a lower end of the third chamber 33. The other one of the vibration damping bands 20 is mounted to pass an upper end of the third chamber 33, the middle part of the second chamber 32, and a lower end of the first chamber 31. This configuration can achieve a damping effect in a wider area with a fewer number of the vibration damping bands 20.

(2g) In the above-described embodiment, the outer panel 21 is arranged along the outer circumferential surface of the muffler main body 10. However, the outer panel 21 in its entirety does not need to be arranged along the outer circumferential surface of the muffler main body 10. The outer panel 21 needs to be configured to hold at least a part of the vibration damping material 22 with the outer circumferential surface of the muffler main body 10 in a state where the outer panel 21 is mounted on the outer circumferential surface of the muffler main body 10.

(2h) Although the outer panel 21 is fixed by a bolt and a nut in the above-described embodiment, a configuration of fixing the outer panel 21 is not limited to that. For example, the outer panel 21 may be fixed by welding.

(2i) In the above-described embodiment, the vibration damping material 22 is arranged to be held between the outer circumferential surface of the muffler main body 10 and the outer panel 21, and is applied with a tension. However, the vibration damping material 22 does not need to be applied with a tension that is caused by being extended in the extension and contraction direction when being arranged to be held between the outer circumferential surface of the muffler main body 10 and the outer panel 21. Even in this case, a damping effect can be achieved if the vibration damping material 22 is elastic. The reason is considered as follows. When the vibration damping material 22 is held between the outer circumferential surface of the muffler main body 10 and the outer panel 21, the vibration damping material 22 is brought into a compressed state and is applied with a tension. Thus, a force of pulling the vibration damping material 22 in a shearing direction by the surface of the muffler main body 10 is generated. As a result, vibration energy is converted into thermal energy, and vibration is damped, and thus radiated noise from the muffler main body 10 can be reduced.

(2j) In the above-described embodiment, a configuration is exemplified in which the vibration damping material 22 extends straight from the first portion 251 to the second portion 261, and extends straight from the second portion 261 to the third portion 271. However, the vibration damping material 22 is not limited to this shape. For example, the vibration damping material 22 may have a meandering shape from the first portion 251 to the second portion 261. Also, the vibration damping material 22 may have a meandering shape from the second portion 261 to the third portion 271.

(2k) One or more functions performed by a single element in the above-described embodiments may be achieved by a plurality of elements, or one or more functions performed by a plurality of elements may be achieved by a single element. Also, a part of a configuration in the above-described embodiments may be omitted. Moreover, at least a part of a configuration in the above-described embodiments may be added to, or may replace, another configuration in the above-described embodiments.

What is claimed is:

1. A vibration damping band to be mounted on an outer circumferential surface of a muffler main body, the vibration damping band comprising:
a vibration damping material having elasticity configured to be arranged on the outer circumferential surface of the muffler main body; and
an outer panel arranged outside an outer lateral surface of the vibration damping material.

2. The vibration damping band according to claim 1,
wherein the vibration damping material is fixed to the outer panel at least in a first fixing position and a second fixing position of the outer panel, and
wherein the vibration damping material comprises at least a first portion fixed in the first fixing position and a second portion fixed in the second fixing position, the vibration damping material being extendable between the first portion and the second portion.

3. The vibration damping band according to claim 2,
wherein a length of the vibration damping material from the first portion to the second portion is shorter than a length from the first fixing position to the second fixing position of the outer panel.

4. The vibration damping band according to claim 1,
wherein the vibration damping material is fixed to the outer panel at least in two positions of the outer panel.

5. The vibration damping band according to claim 1, further comprising:
a swaging component,
wherein the outer panel and the vibration damping material are folded and swaged by the swaging component, and thereby the outer panel and the vibration damping material are fixed together.

6. The vibration damping band according to claim 1,
wherein the outer panel comprises two or more members configured to be arranged along an outer circumferential direction of the muffler main body, the two or more members surrounding the outer circumferential surface of the muffler main body.

7. A muffler comprising:
a muffler main body; and
a vibration damping band mounted on an outer circumferential surface of the muffler main body,
wherein the vibration damping band comprises:
a vibration damping material having elasticity arranged on the outer circumferential surface of the muffler main body; and
an outer panel arranged on an outer lateral surface of the vibration damping material.

8. The muffler according to claim 7,
wherein the muffler main body comprises at least one separator, and
wherein the vibration damping band is provided in a position of the outer circumferential surface of the muffler main body, the position being spaced from a region in which an outer periphery of the at least one separator abuts an inner circumferential surface of the muffler main body.
